(19) United States
(12) Patent Application Publication
(10) Pub. No.: US 2007/0130952 A1
(43) Pub. Date: Jun. 14, 2007

(54) Exhaust heat augmentation in a combined cycle power plant

(75) Inventor: John H. Copen, Oviedo, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/297,063

(22) Filed: Dec. 8, 2005

(51) Int. Cl. F02C 6/18

(52) U.S. Cl. 60/772; 60/39.182

(57) ABSTRACT

A method and system for augmenting the output of a combined cycle power plant having a base gas turbine (22) driving a generator (36) and a heat recovery steam generator (42) that recovers exhaust heat (30) from the base gas turbine (22) to drive a steam turbine (60). A complementary gas turbine engine (12) is added to the power plant to drive a complementary generator (14). The exhaust (A, B, C) of the complementary gas turbine (12) is merged into the flow path of exhaust gas (30) from the base gas turbine (22) upstream of a selected one or more heat exchangers (46, 50, 52) in the heat recovery steam generator (42). Such a complementary system (10) may be used together with supplemental duct burners (48) in a hybrid augmentation embodiment.

### FIELD OF THE INVENTION

This invention relates generally to the field of combined cycle power plants.

### BACKGROUND OF THE INVENTION

A “topping cycle” generates electricity and/or mechanical energy first, and produces waste heat secondarily as a byproduct. A “bottoming cycle” recovers waste heat from a topping cycle to generate electricity and/or mechanical energy. Combined cycle power plants combine a topping cycle and a bottoming cycle to maximize fuel efficiency. Combined cycle power plants are known as efficient means for converting fossil fuels to electrical energy. These plants may have both a gas turbine (GT) and a steam turbine (ST) driving electrical generators. Exhaust heat from the gas turbine is recovered by a heat recovery steam generator to drive the steam turbine.

A heat recovery steam generator (HRSG) is a heat exchange device that uses the hot exhaust from a topping cycle such as a gas turbine to generate steam. This steam is used to generate electricity in a steam turbine. The exhaust then exits the HRSG through a stack. HRSGs may comprise a plurality of sections, such as a low pressure (LP) section, an intermediate pressure (IP) section, and a high pressure (HP) section. Each section HP, IP, and LP may include an evaporator where water is converted to steam, or an LP section may preheat water for an IP section. The steam may pass through additional heat exchangers in the exhaust path called superheaters to raise its temperature and pressure. Some HRSGs include supplemental burners in the exhaust path. These provide additional heat to increase the output of the steam turbine under peak demand conditions.

Power plants are subject to widely varying demand loads from the electric power grid. They must respond to these changing loads while maintaining efficiency. However, it is expensive to purchase and maintain basic plant capacity for peak loads. Much of this capacity would usually be idle, so a lesser base capacity is usually provided and supplemented with lower efficiency power augmentation such as supplemental burners as mentioned above. Supplemental firing may be accomplished in the HRSG or upstream of the HRSG, such as in an afterburner on the GT. These firings use GT exhaust gas as the oxidizer. This gas has reduced oxygen content compared to the ambient atmosphere due to previous combustion, and is not highly compressed. Thus, these firings are inefficient by comparison to combustion in the gas turbine combustor. However, they can provide a large immediate increase of heat to the HRSG. Such methods are sufficient in terms of capacity, but as fuel resources become scarce, it is important to improve methods of achieving high plant peak output while maintaining the highest plant efficiencies and the lowest plant life cycle cost.

A base plant capacity and supplemented capacity may be balanced by a cost/benefit analyses. Tradeoffs are costs of base capacity versus costs of less efficient supplemented operation during peak loads. However, if fuel costs and/or power demand rises faster than predicted, a plant that was optimized prior to installation may subsequently show excessive operating costs due to frequent supplemented operation with expensive fuel.

The gas turbine engines in power plants are optimized for continuous, efficient, reliable operation at a fixed speed. They are not adapted for fast starts or variable speed operation, as are aircraft propulsion gas turbine engines. Combined cycle power plants require substantial energy and time to bring both the gas and steam turbine systems to operational speed and temperature after a plant shutdown.

### BRIEF DESCRIPTION OF THE DRAWINGS

The invention is explained in following description in view of the drawings that show:

FIG. 1 is a schematic prior art view of a combined cycle power plant with a gas turbine, a steam turbine, a heat recovery steam generator, and supplemental burners for peak loads.

FIG. 2 is a schematic view of a combined cycle power plant as in FIG. 1 with the addition of a complementary gas turbine with its exhaust merged into the heat recovery steam generator.

FIG. 3 is a table comparing the performance of complementary augmentation as in FIG. 2 versus unsupplemented base firing or conventional supplementary augmentation as in FIG. 1.

FIG. 4 is a graph showing the change in power and heat rate over a range of ambient temperatures for complementary augmentation versus conventional supplementary augmentation at the same level of fuel flow.

FIG. 5 is a graph of maximum plant power using complementary or hybrid augmentation versus duct firing over a range of ambient temperatures.

FIG. 6 is a graph of maximum plant heat rates corresponding to the respective power curves of FIG. 5 using complementary or hybrid augmentation versus duct firing over a range of temperatures.

### DETAILED DESCRIPTION OF THE INVENTION

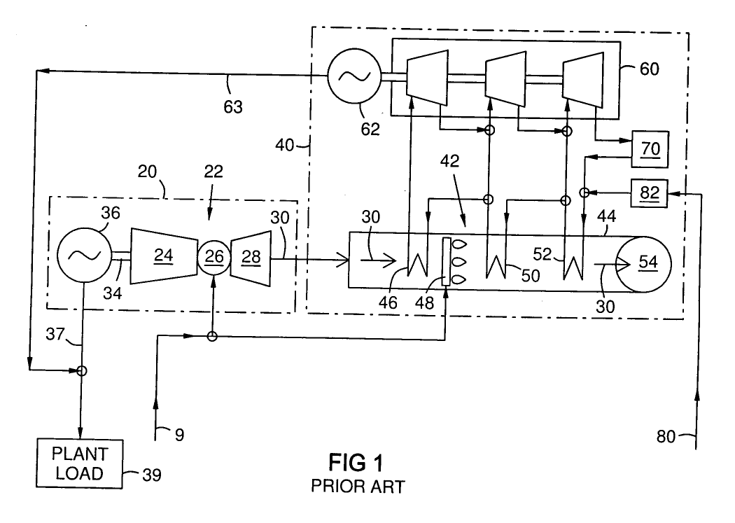

FIG. 1 is a schematic diagram of a prior art combined cycle power plant comprising a base topping cycle 20, and a base bottoming cycle 40. The topping cycle comprises a base gas turbine engine 22 with a compression section 24, a combustion section 26, a turbine section 28, an exhaust flow 30, and a power output shaft 34 that drives a generator 36 for electrical output 37. A fuel flow 9 is provided to the combustion section 26. The bottoming cycle 40 comprises a heat recovery steam generator (HRSG) 42 with a gas duct 44 and one or more heat exchangers 46, 50, 52 that transfer heat from the exhaust flow 30 to water 70, 80 to generate steam for powering steam turbines 60 and/or for cogeneration uses such as factory heating or manufacturing (not illustrated). A given heat exchange loop 46, 50, 52 may include several elements, such as preheater, drum, evaporator, and superheater, as known in the art. These elements heat incoming water pumped 82 from an external water source 80 and/or recovered from a condenser 70. The heat exchangers 46, 50, 52 may be mounted in the HRSG duct 44 such that a first stage of water heating occurs at the downstream end of the HRSG, and progressively hotter stages occur progressively upstream. The exhaust gas 30 cools as it flows over the heat exchangers 46, 50, 52 and transfers heat to them, eventually exiting the plant via an exhaust stack 54. Steam at different temperatures and pressures may be extracted at different points along the series of heat exchangers 46, 50, 52. Some of this steam may be routed to a steam turbine 60 driving a generator 62 for electrical output 63 and/or to cogeneration uses. Other portions of this steam may be routed to heat exchangers upstream in the HRSG 42 for additional heating to recover as much energy as possible from the exhaust gas and provide high pressure steam for the steam turbine 60 and other uses. For example, the downstream heat exchanger 52 may provide low-pressure steam to a low-pressure steam turbine, and/or it may provide low-pressure steam or hot water to another exchanger 50. The above-described elements of FIG. 1 and their interconnections and controls are well known in a variety of configurations, FIG. 1 being a conceptual view.

Supplementary heating of the exhaust gas flow 30 may be provided by additional burners, such as one or more duct burners 48 in the HRSG 42. These burners use the base turbine exhaust gas 30 as the fuel oxidizer, and will be termed “supplementary” herein. Such supplementary heating and its interconnections and controls are well known in a variety of configurations.

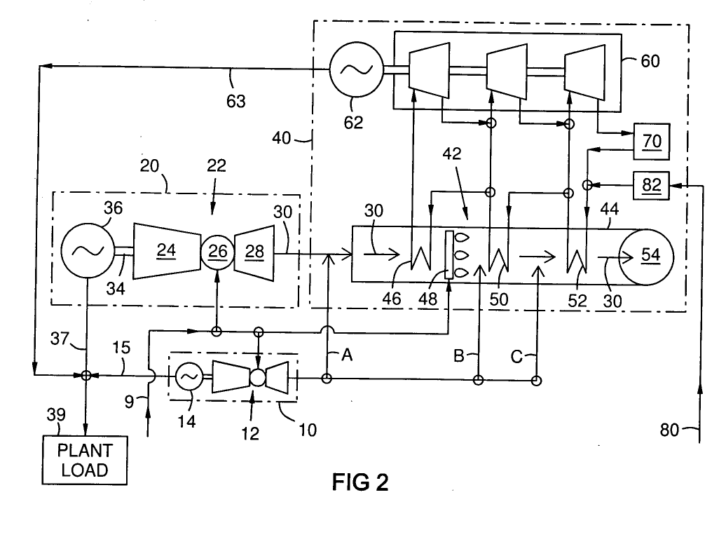

As shown in FIG. 2, one concept of the present invention is the introduction of additional heat into the exhaust gas flow path 30 of a base GT/HRSG set 22, 42 by in-fluxing the waste heat A, B, C of a complementary system 10 comprising an internal combustion engine such as a GT 12. Shaft power generated by the gas turbine may typically be used to power a generator 14 for electrical output 15, although other uses of the shaft power may be envisioned. Other types of internal combustion engines may be used to provide the additional heat, such as for example a diesel or spark ignition engine. The exemplary embodiment of a complementary gas turbine engine 12 described herein is particularly well suited for interfacing with the bottoming cycle HRSG 42. This type of augmentation system will be termed “complementary” herein. Additional fuel to augment the HRSG/ST 40 output is combusted in the complementary GT 12. The exhaust A, B, C of the complementary GT 12 is merged into the base exhaust gas path 30 in the HRSG 42 and/or upstream of the HRSG 42. This differs from the conventional peak loading schemes described above, known as supplementary firing, in which fuel is combusted directly in the base exhaust gas path 30. Complementary augmentation can be combined with supplementary augmentation in a hybrid augmentation system as shown in FIG. 2, or complementary augmentation may be provided without supplementary augmentation.

Complementary augmentation systems achieve higher peak efficiencies than do conventional supplementary heating systems. A complementary system can be built-in to new plants or retrofitted to existing plants to upgrade them and extend their useful life. The complementary system can be packaged in a transportable unit comprising a GT 12, and an electrical generator 14. The complementary system may be a commercially available industrial gas turbine system such as Siemens SGT-400 or SGT-800.

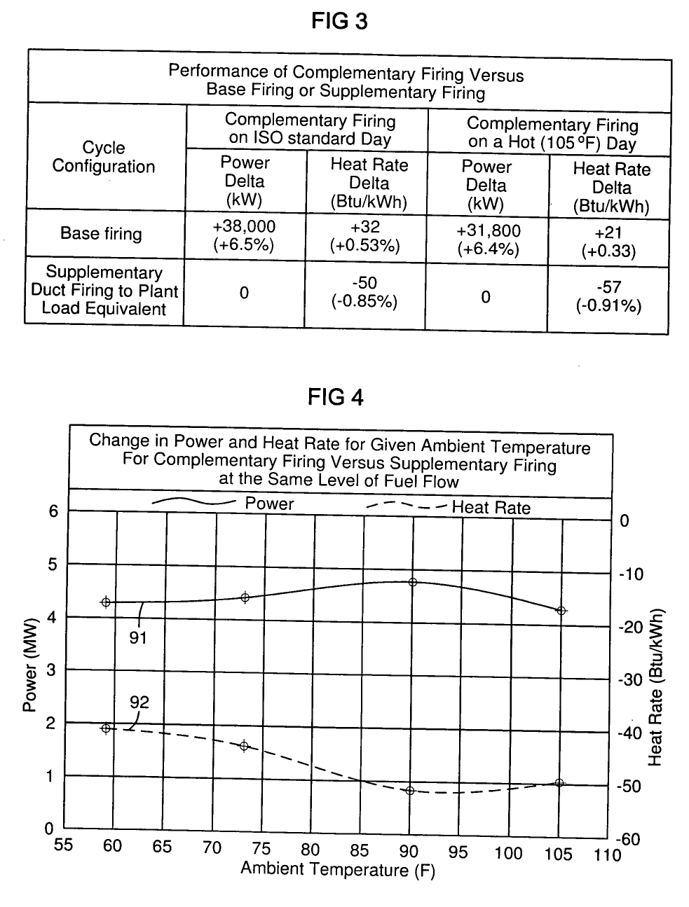

FIGS. 3-6 compare the performance of complementary augmentation, supplementary augmentation, and hybrid augmentation. This data is based on thermodynamic modeling of a model SCC6-5000F 2X1 Reference Power Plant provided by Siemens Power Generation, Inc., the assignee of the present invention. This model simulates an SCC6-5000F 2X1 Nominal 600 MW power plant, comprising two SGT6-5000F nominal 200 MW gas turbines, each having a HRSG, one SST6-5000 nominal 220 MW steam turbine, and two SGT-500 nominal 13 MW complementary gas turbines, each ducted to a respective one of the HRSGs. In this data the heat rate equals the Btu content of the fuel input divided by the kilowaft-hours of power output; thus, a lower heat rate value is indicative of a higher plant efficiency. Natural gas fueled all burners and combustors in the simulation.

FIG. 3 shows two aspects of power plant performance. The first row of data illustrates operation where the supplemental firing is done without decreasing the base load firing in order to increase the peak power output of the plant. In this situation a power increase of 6.4-6.5% (depending upon ambient temperature) is achieved with complementary firing when compared to base firing (unaugmented), with a disproportionately small heat rate increase of only 0.33-0.53%. This means that the peak power addition provided by the complementary firing is achieved at a higher degree of efficiency than the overall base plant efficiency. The second row of data compares complementary firing verses the prior art supplemental firing to achieve the same overall plant output. In this example, the heat rate using complementary firing is less than with supplementary duct firing at the same plant load level, thereby demonstrating that complementary firing achieves a higher degree of plant efficiency than does supplementary firing at a given plant power output. Thus, FIG. 3 illustrates the availability of a significant power increase with complementary augmentation over base firing at a higher level of efficiency than would be achieved with duct firing for a given augmented power level.

FIGS. 4-6 illustrate further aspects of embodiments of the invention. In FIG. 4 the upper curve (91) illustrates the additional plant power output achieved using complementary firing versus supplementary firing over a range of ambient temperatures with fuel flow held constant, as indicated on the vertical scale on the left. The lower curve (92) illustrates the improvement in plant heat rate achieved using complementary firing versus supplementary firing over a range of ambient temperatures with fuel flow held constant, as indicated on the vertical scale on the right The two curves in FIG. 4 are each based on four data points modeled at 59° F. (ISO), 73° F., 90° F., and 105° F. The two curves shown are each averaged from three curves representing three positions of complementary heat mixing into the base exhaust flow path as shown in FIG. 2: A) after the base gas turbine 22 and proximate the HRSG 42 inlet; B) at an intermediate point in the HRSG 42; and C) at a point further downstream within the HRSG 42. The use of such averaged data is appropriate and representative for illustration purposes since the choice of the location where the complementary heat is inserted into the base plant exhaust gas flow generates little change in this data. FIG. 4 shows that complementary augmentation provides greater power outputs and lower heat rates (higher plant efficiency) at all ambient temperatures from 59° F. to 105° F. for a given fuel flow than does conventional supplementary augmentation.

A complementary system works well in high ambient temperature peaking situations, since the design basis for the base HRSG is a cold day when the largest flue gas mass flows are achieved. As ambient temperatures increase, the base GT exhaust mass flows decrease, allowing ample flue gas mass flow augmentation capacity. Furthermore, a complementary system or a hybrid complementary/supplementary system has the ability to add plant capacity at reasonable heat rates at low ambient temperatures. This is in contrast to supplementary firing systems that usually must be turned down or off as ambient temperature reductions increase the base GT exhaust energy, resulting in attainment of design steam pressure limits. Accordingly the complementary system can be operated responsive to a sensed ambient condition and/or a sensed mass flow rate condition. A complementary firing system does not require bottoming cycle design criteria (flue gas temperature, steam pressures, etc.) as high as those for conventional duct firing, and in retrofit applications, a pre-existing design pressure or temperature limit does not render a complementary firing system inoperable.

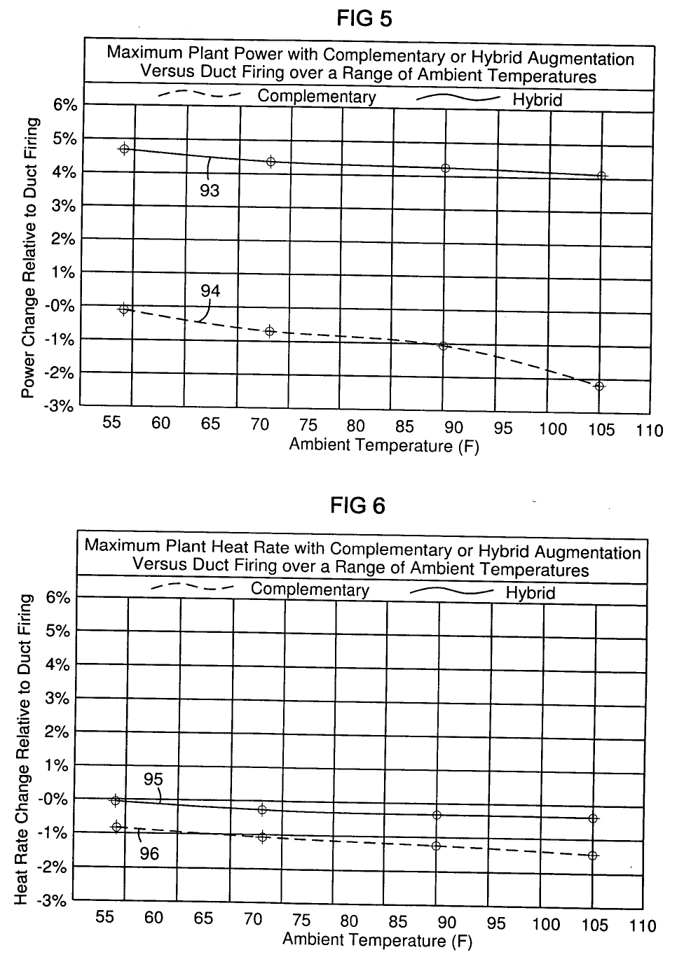

FIG. 5 compares a maximum plant capacity using complementary versus duct firing (94) and hybrid versus duct firing (93) over a range of ambient temperatures. FIG. 6 compares the maximum plant heat rate for complementary firing versus duct firing (96) and for hybrid versus duct firing (95) for the corresponding maximum plant outputs of FIG. 5 over the same range of ambient temperatures. These curves show that hybrid augmentation can provide higher peak power at a lower heat rate than duct firing alone. Hybrid augmentation also provides higher peak power than complementary augmentation alone, with only a small penalty in heat rate. Hybrid augmentation provides greater peak power than duct firing alone partly because it increases the mass flow of gas through the HRSG. This provides a greater transfer of energy to the water while staying within temperature limits of the HRSG. In addition, the hybrid system contributes complementary GT shaft power as well as heat.

The complementary system 10 may comprise a gas turbine 12 with a fast startup capability that can be brought on-line on short notice as needed. It can be controlled manually or automatically using inputs that may include ambient air conditions, power demand conditions, percentage utilization of duct 44 gas flow capacity, and/or percentage of steam pressure and temperature limits, etc. and/or values derived from such inputs. Ducting of complementary exhaust A, B, C may be made to multiple points as shown, or to a single point, such as A or B or C. If multiple entry points are used, a complementary exhaust distribution manifold may be provided with gas flow valves to select optimum distribution configurations depending on sensed conditions.

A complementary system 10 may be provided in transportable form such as a skid-mounted device for retrofit installations and for flexibility in power plant reconfigurations. One complementary system 10 may serve one or more base generation sets 20, 40. Conversely, multiple complementary systems 10 may serve a single generation set 20, 40. In addition, a complementary system 10 with a fast startup GT may replace a plant's black start equipment, which may typically be a stand-alone diesel and/or gasoline powered generator. When the base GT 22 and ST 60 are stopped, the complementary system 10 may be operable with the base HRSG 42 and/or it may have a smaller HRSG to provide initializing steam for starting the base cycles 20, 40. This provides necessary conditions such as seal steam and warming that will enable a more rapid start sequence of the entire combined cycle plant. The complementary system 10 may also be operated in a power island mode to provide auxiliary power to the overall plant when the plant is in a standby or non-dispatched mode.

A hybrid augmentation system can achieve its highest peak output if the complementary system is first increased to its maximum contribution, then the duct heating is increased to its maximum contribution. This allows an increased gas mass flow to provide a favorable environment for additional duct burning without exceeding local temperature limits and with more oxidizer throughput.

A complementary system may be used along with known gas turbine enhancements and modes such as steam or water injection in a GT combustor, evaporative cooling in a GT inlet, and others, either on the base GT and/or the complementary GT. A base system, complementary system, and supplementary system may be fueled with any combination of fuels known in the art, such as natural gas, synthetic gas, oil, and others. Synthetic gas may be produced as known in Integrated Gasification Combined Cycle (IGCC) technology. Alternate fuels may be used in any burner or combustor to provide plant design and operational flexibility. While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A combined cycle power plant comprising:
a base topping cycle comprising a base gas turbine combusting fuel to produce power and a base exhaust gas flow;
a base bottoming cycle comprising an exhaust gas flow path receiving the base exhaust gas flow, the exhaust gas flow path comprising a heat recovery steam generator producing steam, and a steam turbine receiving the steam and producing power; and
a complementary gas turbine combusting fuel to produce power and providing a complementary exhaust gas flow to the base bottoming cycle exhaust gas flow path for augmenting the base bottoming cycle power production.

2. The combined cycle power plant of claim 1, further comprising a supplemental duct burner combusting fuel in the exhaust gas flow path for further augmenting the base bottoming cycle power production.

3. The combined cycle power plant of claim 1, wherein the complementary exhaust gas flow in introduced into the base bottoming cycle exhaust gas flow path at a location upstream of the heat recovery steam generator.

4. The combined cycle power plant of claim 1, wherein the complementary exhaust gas flow in introduced into the base bottoming cycle exhaust gas flow path at a location within the heat recovery steam generator.

5. The combined cycle power plant of claim 1, wherein the complementary gas turbine comprises a transportable skid-mounted device for incorporation into the power plant on a back-fit basis.

6. A combined cycle power plant comprising:
a heat recovery steam generator comprising an exhaust gas flow path and a heat exchanger disposed in the exhaust gas flow path to transfer heat from the exhaust gas flow path to a working fluid;
a topping cycle comprising an exhaust connected to the exhaust gas flow path; and
a complementary internal combustion engine comprising an exhaust connected to the exhaust gas flow path for providing complementary exhaust gas to the heat exchange.

7. The combined cycle power plant of claim 6, wherein the topping cycle comprises a base gas turbine and the complementary internal combustion engine comprises a complementary gas turbine.

8. The combined cycle power plant of claim 6, further comprising a supplementary fuel burner in the exhaust gas flow path.

9. In a combined cycle power plant comprising a base gas turbine driving a first electrical generator, a heat recovery steam generator comprising a plurality of heat exchangers mounted in a flow path of exhaust gas received from the base gas turbine, and a steam turbine receiving steam from at least one of the heat exchangers and driving the first or a second electrical generator, an energy augmentation apparatus comprising:
a complementary gas turbine driving a complementary electrical generator and comprising an exhaust section producing complementary exhaust gas; and
a connection introducing the complementary exhaust gas into the flow path of exhaust gas from the base gas turbine upstream of a selected one or more of the heat exchangers.

10. The energy augmentation apparatus of claim 9, wherein the connection comprises a plurality of flow paths for introducing the complementary exhaust gas into the flow path of exhaust gas from the base gas turbine at one or more alternative locations relative to the plurality of heat exchangers.

11. A method for augmenting the power output of a combined cycle power plant, the power plant comprising a base gas turbine with an exhaust section ducted to a heat recovery steam generator comprising an exhaust flow path in which are disposed a plurality of heat exchangers for transferring heat from the exhaust flow path to a working fluid, the method comprising;
adding to the power plant a complementary internal combustion engine comprising an exhaust section that produces complementary exhaust gas;
ducting the complementary exhaust gas into the exhaust flow path; and
controlling the complementary internal combustion engine to add complementary heat to the heat recovery steam generator.

12. The method of claim 11, wherein the controlling step comprises controlling the complementary internal combustion engine responsive to a sensed ambient condition.

13. The method of claim 11, wherein the controlling step comprises controlling the complementary internal combustion engine responsive to a mass flow rate passing through the exhaust flow path.

14. The method of claim 11, further comprising controlling a supplementary fuel burner in the exhaust flow path in coordination with controlling the complementary internal combustion engine to add heat to the heat recovery steam generator.

15. The method of claim 14, further comprising:
first, controlling the base gas turbine and the complementary internal combustion engine to a combined maximum power output for a given ambient condition; and
second, controlling the supplementary fuel burner to produce additional plant power beyond the combined maximum power output of the base gas turbine and complementary internal combustion engine.

16. The method of claim 11, further comprising providing the complementary internal combustion engine as a transportable unit for augmenting the power output of an existing combined cycle power plant.

17. The method of claim 11, implemented on two combined cycle power plants using a single complementary internal combustion engine.

18. A method of generating power in a combined cycle power plant, the method comprising:
producing shaft power by expanding a first hot compressed gas flow through a first gas turbine, thereby producing a first flow of hot expanded gas;
passing the first flow of hot expanded gas through a heat exchanger to produce pressurized steam;
producing additional shaft power expanding the pressurized steam through a steam turbine;
producing further additional shaft power by expanding a second hot compressed gas flow through a second gas turbine, thereby producing a second flow of hot expanded gas; and
merging the second flow of hot expanded gas with the first flow of hot expanded gas at a position upstream of said heat exchanger for augmenting the pressurized steam production.

19. The method of claim 18, further comprising burning fuel in the first flow of hot expanded gas upstream of the heat exchanger.

20. The method of claim 18, further comprising:
first, maximizing combined generated shaft power for a given ambient condition using the steps of claim 18; and
second, increasing the shaft power generated by the steam turbine by burning fuel in the first flow of hot expanded gas upstream of the heat exchanger.
